(19) United States
(12) Patent Application Publication
(10) Pub. No.: US 2005/0209932 A1
(43) Pub. Date: Sep. 22, 2005

(54) Interactive online marketplace system and method

(75) Inventor: Wan Sang Hui, Taikoktsui (HK)

Correspondence Address: LEYDIG VOIT & MAYER, LTD, 700 THIRTEENTH ST. NW, SUITE 300, WASHINGTON, DC, 20005-3960, US

(73) Assignee: Cyber Business Network (Hong Kong) Limited, Kwun Tong (HK)

(21) Appl. No.: 10/803,048

(22) Filed: Mar. 18, 2004

(51) Int. Cl. G06F 17/60

(52) U.S. Cl. 705/27; 705/26

(57) ABSTRACT

An interactive online marketplace system comprises a server and a database associated with the server for storing details of traders and customers including information of products and/or services provided by the traders. Each of the traders and customers is identified by a user having a unique identity code. Computers used by the traders and customers are connectable to the server. A website associated with the server allows visit by the customers using the computers, with a webpage displayed on the computer of a visiting customer. The webpage includes a directory of the traders in a multi-level representation that includes hyper links to corresponding users representing the traders based on their identity codes for establishing a two-way online communication channel via the server between the visiting customer and one of the traders selected by that customer.

The present invention relates to an interactive online marketplace system and method.

### BACKGROUND OF THE INVENTION

Existing e-Commerce systems provide a marketplace platform, on which a customer can seek an online shop, review the product description on the website of a selected shop, and then complete a transaction if appropriate, but there are limitations particularly if the customer has questions. When that happens, the customer has to send an e-mail or fax or make a call, whereby his decision making process is interrupted. Customers will often get side-tracked, and retailers frequently lose business because of this interruption. Thus, existing e-Commerce solutions does not in fact operate like commerce in the real world.

The invention seeks to mitigate or at least alleviate such a problem by providing an interactive online marketplace system and method.

### SUMMARY OF THE INVENTION

According to a first aspect of the invention, there is provided an interactive online marketplace system comprising at least one server and a database associated with the server for storing details of traders and customers including information of products and/or services provided by the traders. Each of the traders and customers is identified by or as at least one user having a unique identity code. Included are communication devices for use by the traders and customers and connectable to the server. There are also included a website associated with the server for visit by the customers using the communication devices, and a webpage for display on the communication device of a visiting customer. The webpage includes a directory of the traders in a multi-level representation that includes hyper links to corresponding users representing the traders based on their identity codes for establishing a two-way online communication channel via the server between the visiting customer and one of the traders selected by that customer.

Preferably, the directory is to be displayed in the format of a tree diagram.

Preferably, the traders in the directory are listed according to their business nature at one level and then product/service type at a lower level.

More preferably, the traders in the directory are listed according to their names, or the names of their representatives, at a further lower level.

Further more preferably, the names are associated with means for obtaining information from the traders represented by the names.

It is preferred that the names are associated with the hyper links respectively to establish a said two-way online communication channel between two users for a chat session comprising sending a message.

It is further preferred that the message comprises one of text and voice messages.

It is yet further preferred that the message includes sharing one of file and webpage.

In a preferred embodiment, the names are selectable for adding to a contact list included in the webpage, with each name in the contact list being a hyper link to the corresponding user for communication.

More preferably, the contact list includes an indication to show online status of the users represented by the names in the contact list.

According to a second aspect of the invention, there is provided an interactive online marketplace method comprising the steps of:
(a) providing at least one server and a database associated with the server for storing details of traders and customers including information of products and/or services provided by the traders, and identifying each of the traders and customers by or as at least one user having a unique identity code;
(b) providing communication devices for use by the traders and customers and connectable to the server;
(c) providing a website associated with the server for visit by the customers using the communication devices; and
(d) providing a webpage for display on the communication device of a visiting customer, the webpage including a directory of the traders in a multi-level representation that includes hyper links to corresponding users representing the traders based on their identity codes for establishing a two-way online communication channel via the server between the visiting customer and one of the traders selected by that customer.

Preferably, step (d) includes displaying the directory in the format of a tree diagram.

Preferably, step (d) includes listing the traders in the directory according to their business nature at one level and then product/service type at a lower level.

More preferably, step (d) further includes listing the traders in the directory according to their names, or the names of their representatives, at a further lower level.

Further more preferably, step (d) further includes providing means associated with the names for obtaining information from the traders represented by the names.

It is preferred that step (d) further includes associating the names with the hyper links respectively to establish a said two-way online communication channel between two users for a chat session comprising sending a message.

It is further preferred that the message comprises one of text and voice messages.

It is yet further preferred that the message includes sharing one of file and webpage.

In a preferred embodiment, step (d) further includes rendering the names selectable for adding to a contact list included in the webpage, with each name in the contact list being a hyper link to the corresponding user for communication.

More preferably, step (d) further includes including in the contact list an indication to show online status of the users represented by the names in the contact list.

### BRIEF DESCRIPTION OF DRAWINGS

The invention will now be more particularly described, by way of example only, with reference to the accompanying drawing, in which:

FIG. 1 is a schematic overview diagram of an embodiment of an interactive online marketplace system and method in accordance with the invention;

FIGS. 2A to 2U are screen displays corresponding to various functions of the marketplace system and method of FIG. 1; and

FIG. 3 is a flowchart illustrating the operation of the marketplace system and method for performing the functions of FIGS. 2A to 2U.

### DETAILED DESCRIPTION OF PREFERRED EMBODIMENT

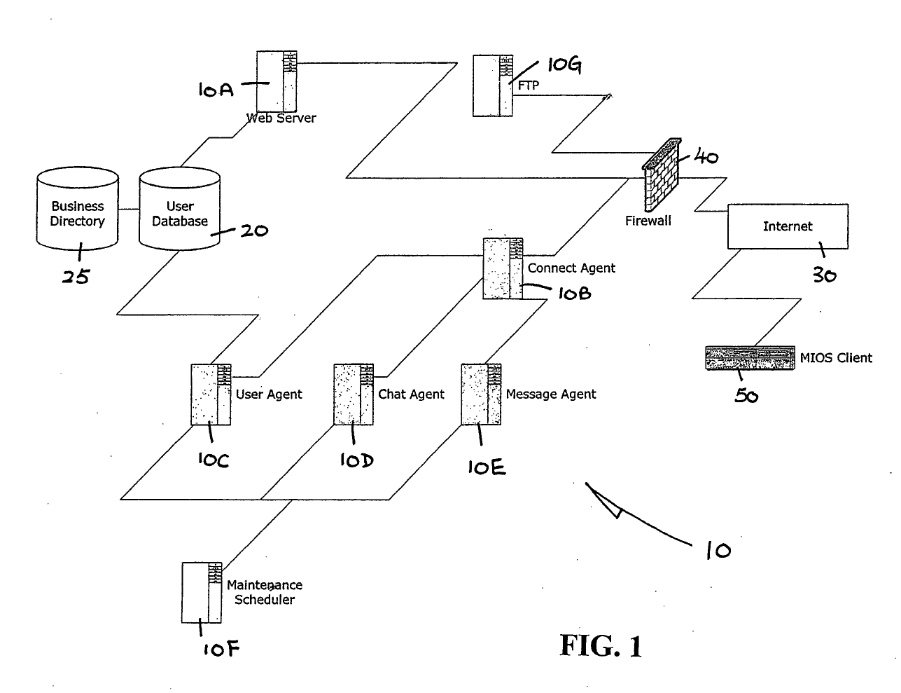

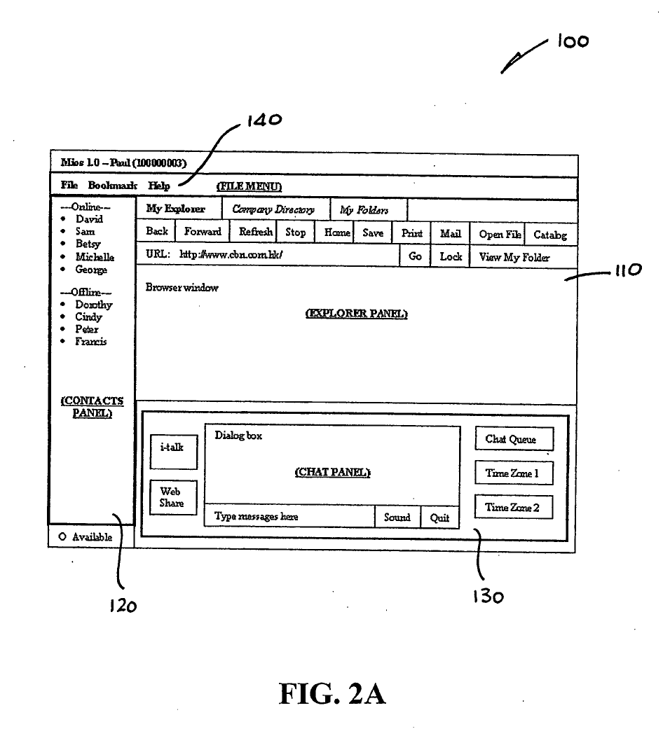

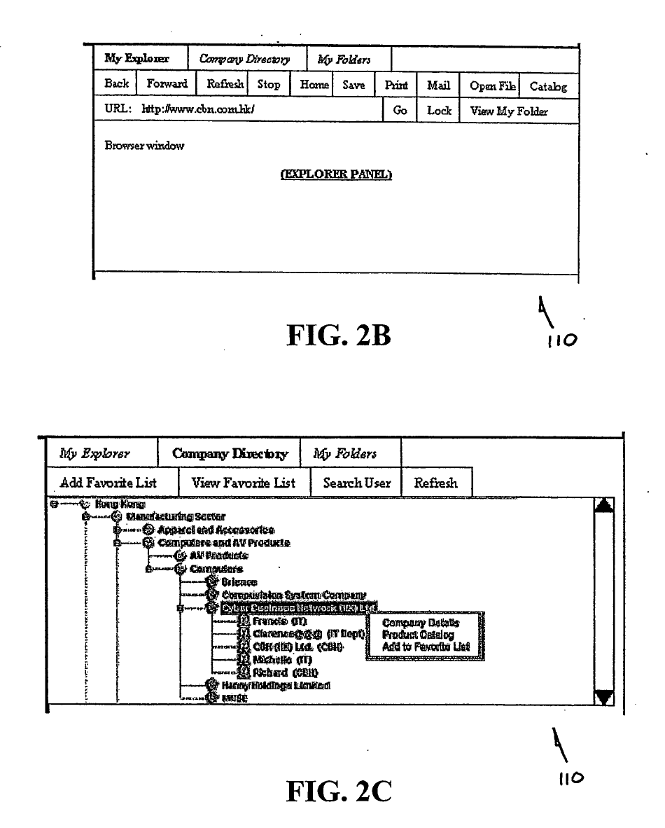

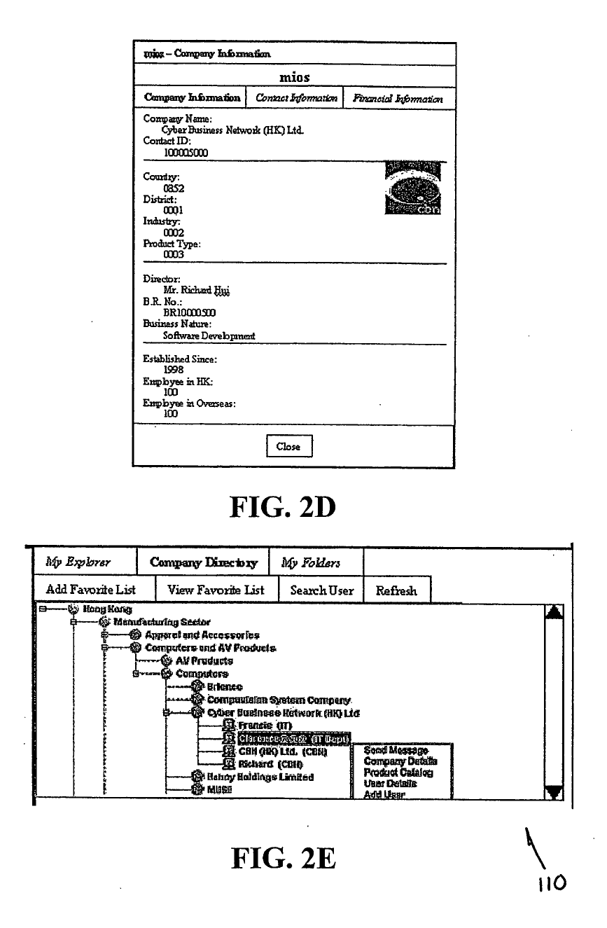

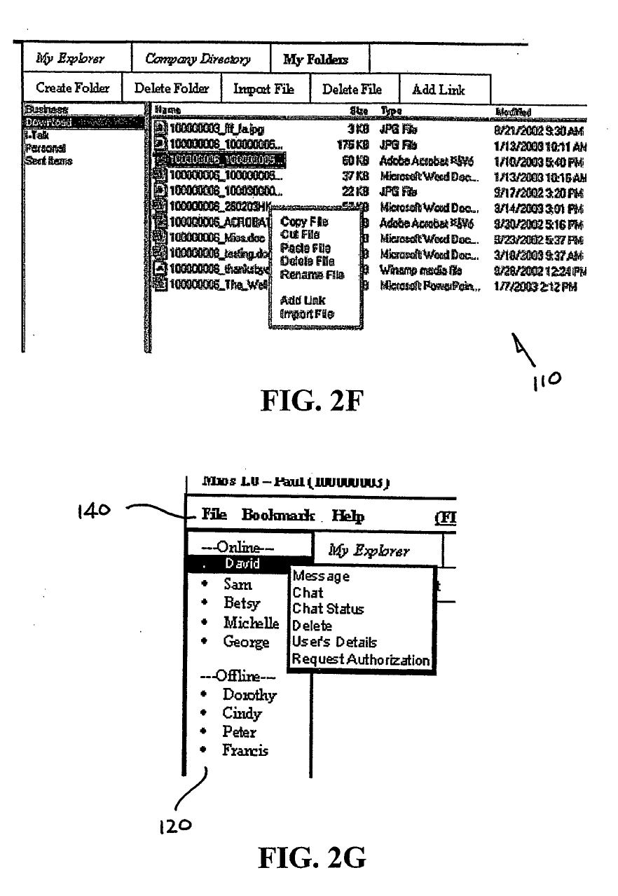

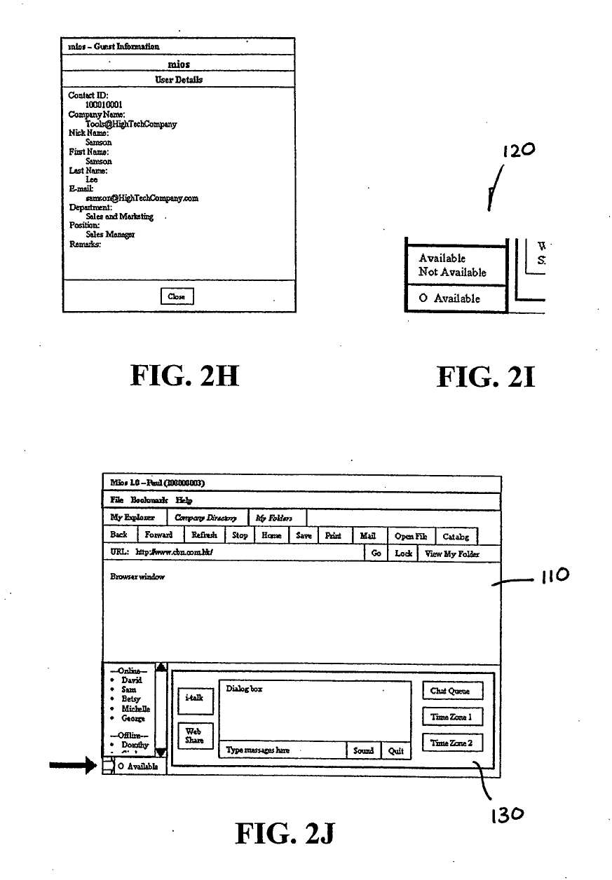

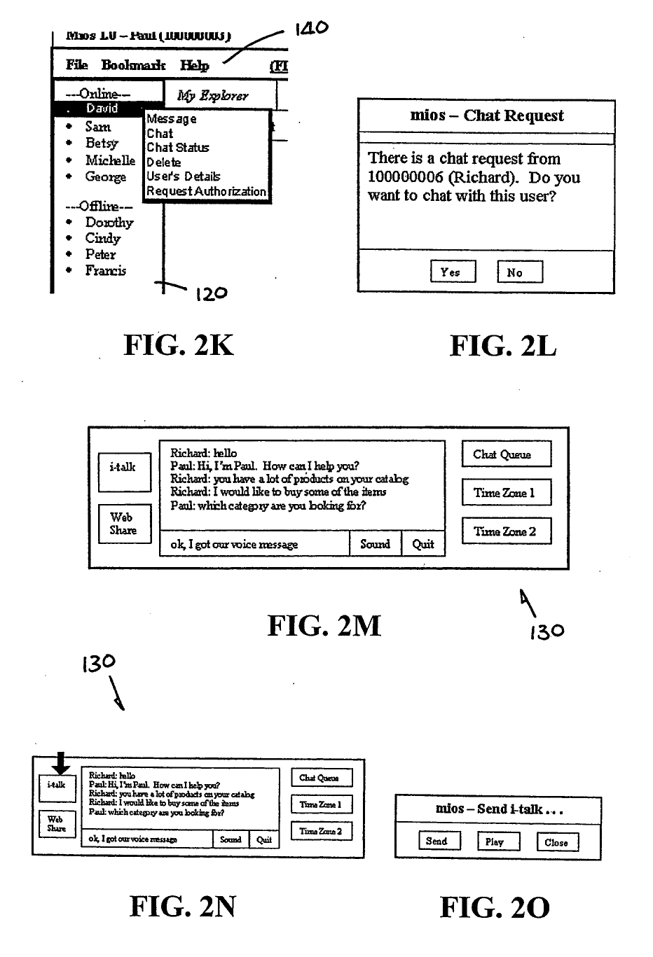

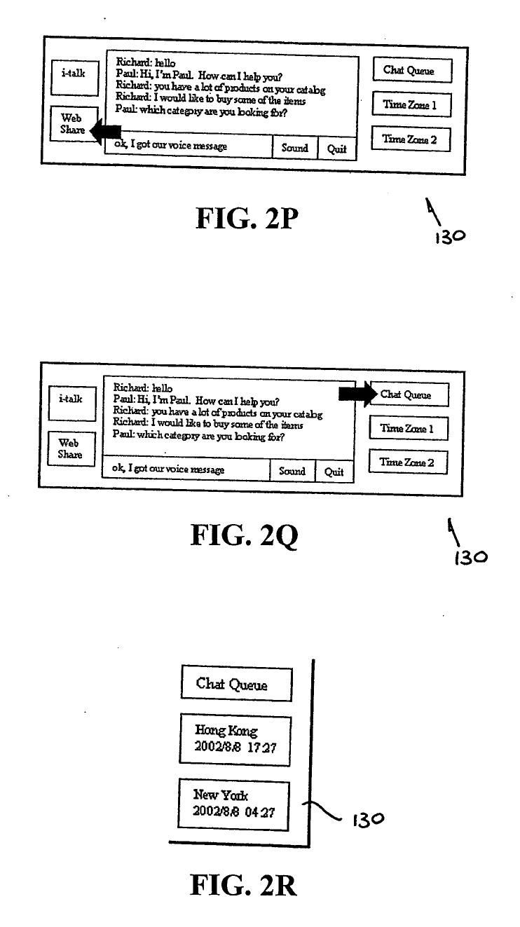

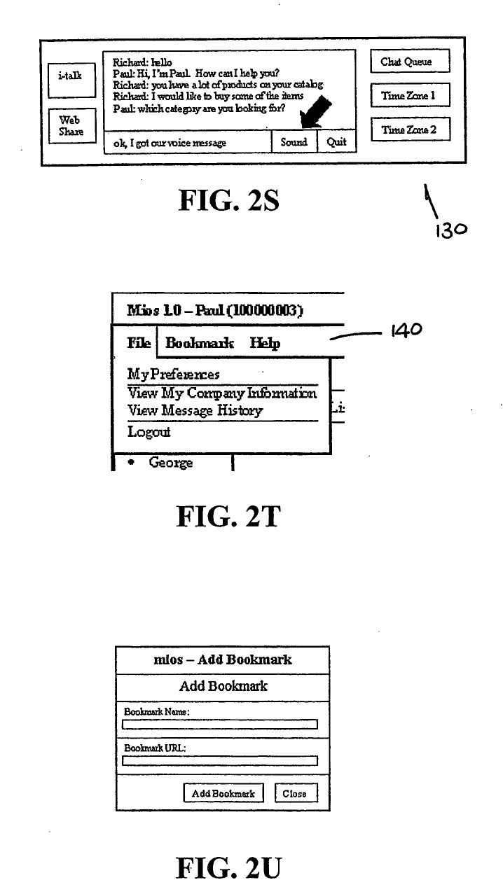

Referring initially to FIGS. 1 and 2A to 2U of the drawings, there are shown an interactive online marketplace system and method embodying the invention, which are hereinafter referred to as MIOS for ease of reference. MIOS is constructed and implemented by a system 10 of seven web servers 10A to 10G, namely a main web server 10A, a connect agent 10B, a user agent 10C, a chat agent 10D, a message agent 10E, a maintenance scheduler 10F and a FTP server 10G. The user, chat and message agents 10C to 10E are connected together in parallel, to which the connect agent 10B and the maintenance scheduler 10F are separately connected. The main server 10A and connect agent 10B are deployed for general controls including running the main and auxiliary programs. In particular, the connect agent 10B acts a controller for the user, chat and message agents 10C to 10E.

The main server 10A and connect agent 10B, together with the FTP server 10G, are connected to the Internet 30 via a firewall 40, and personal (or notebook) computers 50 representing MIOS users, i.e. participating traders and registered customers, are connected to the Internet 30. The firewall 40 protects the whole system by separating all user computers 50 connected thereto.

A user database 20 is connected to the main server 10A, and to the user agent 10C, for storing details of the participating traders and registered customers. Also included in the MIOS system is a business directory database 25 connected to the user database 20 for storing catalogs of products and/or services provided by the traders. The traders are usually companies, shops and similar establishments each being represented by one or more users acting as sales representatives, whereas the customers are usually individuals who may act for corporate customers. Each of the traders and customers is represented by at least one user identified by a unique identity code for access by other users.

The web server 10A hosts a MIOS website. The customers and traders visit the MIOS website by using the computers 50, each installed with a Windows-based MIOS user program, to connect themselves to the server system 10, and in particular the main server 10A and connect agent 10B, for two-way communication with each other. These arrangements allow the users, for example, to exchange written and voice messages and share websites and webpages, or any other documents and files.

The MIOS users communicate with the MIOS server system 10 using TCP protocol (Transmission Control Protocol), in that text-based messages and commands can be uploaded or downloaded through TCP channels established as required on the Internet 30. For text-based messages, the servers 10A to 10G use the store and forward approach to relay messages to or amongst the users. For text-based commands, the servers 10A to 10G react with the commands sent by the users and execute proper actions. For all files to be shared amongst the MIOS users, such as webpages, pdf files, movie files and voice files, etc., FTP protocol (File Transfer Protocol) is used for the users to upload these files to the FTP server 10G or download them from the FTP server 10G.

All traders must first register online, including opening an account and obtaining a login ID and associated password, in order to participate in the MIOS scheme. They also need to upload files, in any standard formats, to the main server 10A, including an introduction of their companies or shops, contact details of their sales representatives, and their product and/or service catalogs or description. Each customer must also register online in advance, supplying some basic information such as contact details and payment methods.

The traders are divided and grouped according to their geographical locations, the natures of their business industries, the main and specific types of products and/or services they provide, and the names of their companies in alphabetical order and/or and the names of their representatives (or subsidiaries, departments, etc). Such data are compiled and listed as a multi-level representation in the format of a tree diagram to facilitate searching, hereinafter referred to as a Company Directory. In the Company Directory, the names of the companies and their representatives are to be displayed acting as hyper links for direct access.

Upon visit, the MIOS website will bring up a user webpage on the display of the computer 50 of the visiting customer logged onto MIOS. The webpage acts as a user-friendly integrated interface that is designed to perform all the functions described herein. The MIOS interface 100 is divided into three main panels, i.e. Explorer Panel 110, Contacts Panel 120, Chat Panel 130, and a Command Menus 140 (FIG. 2A).

In the Explorer Panel 110, there are displayed three tabs representing respective major scopes of functions, i.e. My Explorer, Company Directory and My Folders.

My Explorer is a built-in Microsoft standard web browser with similar function buttons as Internet Explorer, which provides a panel with navigation and file-related buttons (FIG. 2B). The user can browse the web by entering a URL (Uniform Resource Locator) web address and save visited webpages on the bookmark. The user can also open a file/document in the local drive, such as a product catalog, and then revise, save or print the document.

In the Company Directory of FIG. 2C for example, “Hong Kong” is one geographical location at the first level, “Manufacturing Sector” represents a business industry at the second level, and “Apparel and Accessories” and “Computers and AV Products” are two main product types at the third level under “Manufacturing Sector”. Under “Computers and AV Products”, “AV Products” and “Computers” are listed at the fourth level. Under “Computers”, there is a list of company names at the fifth level, each of which is attended by one or more sales representatives at the sixth level. Clicking on a specific company name, such as “Cyber Business Network (HK) Ltd”, will bring up an option menu to retrieve the company details (FIG. 2D), to obtain or download its product/service catalog, and to allow addition of this name to a favourite list for future access.

The Company Directory is an active directory, in that the name of each representative acts as a hyper link to that person representing a specific company. On the Explorer Panel 110, click on the Company Directory tab and the browser below will show a list of companies and their representatives who are online at the time. This list is retrieved from the server at the point in time when the user clicks on the Company Directory tab for the first time since the user logged on. The user may then choose the company and the hierarchical folder list of departments and online users will show up accordingly on the screen. This list, which was retrieved and downloaded once from the server, will remain unchanged when the user stays logged on. During this time, the user is unable to see any new company representatives who have logged on since the user's last download and some of the company representatives shown may have already logged out. It is when the user clicks on the Refresh button on a new retrieval download from the server is triggered and so the user can now see an updated list, which will show the company representatives currently online at the time.

The hyper link is implemented using the identity code of the associated representative for establishing a two-way online TCP communication channel, via the server system 10, between the customer and the trader selected by the customer. The Company Directory may be refreshed using a Refresh button (FIG. 2C) to update the displayed data and in particular the online/offline status and availability of the representatives on a real time basis.

The customer will be able to see who is online and available for a chat under a selected company. By clicking on a representative name to bring up an option menu, the customer can also send a message, view the company details, review the relevant product catalog, see the representative's details, and add the representative to a Contact List.

Thus, the Company Directory is a resourceful list of industries and the corresponding companies and online representatives, which allows a customer to quickly narrow down a company search as he navigates through the geographical and industry sector categories.

My Folders is a file manager (FIG. 2F) that enables a user to upload and organize documents and presentation material in any standard formats, and to create new folders and import files for any applications. This is where product/service catalogs, invoices, quotations and pictures, etc. are stored. The file manager will also list the saved files that are available for the user to share with other MIOS users. Every document and file received from another MIOS user will automatically be stored for convenient review later.

The Contacts Panel 120 (FIG. 2G) provides a quick view of the users that have been added to the Contact List and shows their online/offline status on a real time basis. The Contact List is a list of users built up by a customer adding other users. A specific user name on the list will blink when that user sends in a message, and the message can be read upon clicking on that user name. Right-clicking on a user name will call up an option menu that allows the user to send a text message, send a chat request, check that user's chat status, delete that user from the list, see that user's details (FIG. 2H), and request authorisation to be added to that user's list.

In the Contact List, the users are divided between an upper online list displayed in blue colour and a lower offline list displayed in red colour (FIG. 2G), whereby their online/offline status is clearly shown.

At the bottom of the Contacts Panel 120, there is a status indicator (FIG. 2I) that can be set to “Available” to tell other MIOS users that you are available for contact or switched to “Not Available” to show that you are not ready to communicate with them.

The layout windows can be resized by clicking on and dragging the window panels. The Contacts Panel 120 further includes a Layout Button (FIG. 2J), and appears as appropriate next to the status indicator, for resuming to the original panel format.

The Chat Panel 130 contains the tools that you need to interact, share, exchange data and talk to other MIOS users, i.e. Chat Area, i-talk Button, Web Share Button, Chat Queue, Local/Global Date & Time and Chat Message Indicator.

The Chat Area (FIG. 2M) allows a user to conduct real-time, text-based chat sessions with other MIOS users. A chat session is initiated by right-clicking on the name of the other user, who must be online of course, in the Contact List (FIG. 2K) and then selecting Chat in the option menu to send a chat request. The other user will receive the chat request, with a dialogue box (FIG. 2L) appearing on his/her own computer. After the other user has accepted the chat request, the calling user can type a message and then hit the Enter button of the keyboard. The message will instantly be displayed in an upper chat window and at the same time sent to the other user. All outgoing and incoming messages will be displayed sequentially on the chat areas (FIG. 2M) of both users. A chat session can be terminated by either party hitting a Quit button.

During a chat session, the i-Talk button can be pressed and held to start recording a voice message (FIG. 2N). Recording will end as soon as the button is released, whereupon a dialogue box (FIG. 2O) will appear that allows playing back of the recorded voice message or sending it to the other user. Uninterrupted voice messages can therefore be exchanged between two users to conduct a conversation, which can be invoked as desired at any time during a chat session.

While in a chat session, the Web Share button (FIG. 2P) can be pressed to share files in any standard format, or share webpages being visited on the Explorer Panel 110, with another MIOS user. The web share function can be locked by clicking on a Lock key (FIG. 2A) on the Explorer panel 110 to prevent sharing any webpages with the other user.

The ability to exchange text and voice messages and share files and webpages during a chat session makes communication efficient and versatile.

The Chat Queue (FIG. 2Q) is an icon that indicates the presence of another MIOS user or users waiting to chat with the user, while the user is being occupied in a chat session. The Chat Queue icon will blink to alert the user of a chat request.

The Local/Global Date & Time (FIG. 2R) is a dual display that provides the user with a quick and convenient reference of the local date and time and the same of the other user who may be in a different country or time zone.

There is a sound notification whenever a new chat message arrives, and the Chat Message Notification (FIG. 2S) is a button that can be hit to enable or disable the sound notification.

The Command menus 140 consist of three tabs marked with File, Bookmark and Help. The File tab opens a pull-down menu (FIG. 2T) that contains “My Preference”, “View My Company Information”, “View Message History” and “Logout”.

“My Preferences” allows a user to view or update his/her personal and associated company information, set security level and e-mail setting, change password, and configure system function and proxy server. “View My Company Information” is where the profile and company information of the user are held. “View Message History” is for retrieving stored records of previous chat sessions, and “Log out” is for program exit.

The Bookmark tab opens a dialogue box (FIG. 2U) for adding links into the bookmark for future use, while the user is browsing the web or documents on the Explorer Panel 110. The user can also review the websites and documents saved in the bookmark.

The Help tab is useful to request technical support by sending over a short description of the problem to the MIOS organiser, and to review details of the version of the MIOS program in use.

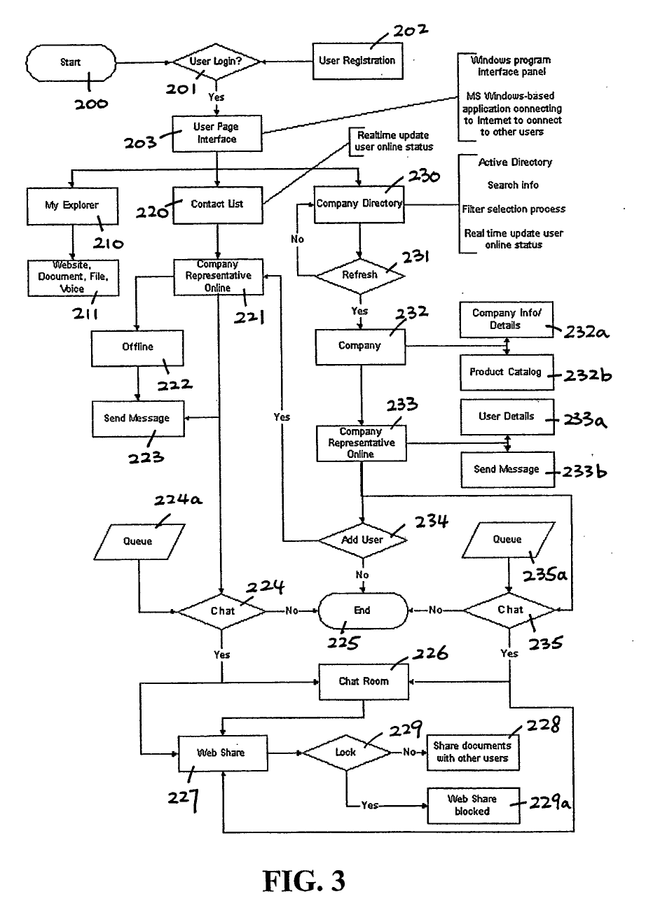

Reference is now made to FIG. 3, which illustrates the procedures of MIOS performing the functions as described above. Upon starting of the MIOS program (Box 200), the user is required to login (Box 201), or otherwise attend to user registration first (Box 202) and then login, and then the user page interface 100 will appear on screen (Box 203). The interface 100 presents, inter alia, the My Explorer tab (Box 210), the Contact List (Box 220) and the Company Directory (Box 230).

The My Explorer tab (Box 210) is useful to call up the panel with navigation and file-related buttons (FIG. 2B) to enable the user to visit websites and work on files and documents and to attend to other tasks such as voice-related tasks (Box 211).

The Contact List (Box 220) shows all the added users, including in particular company representatives (Box 221), with an indication of their online/offline status. Upon selection of one of the representatives for communication, the user may send over a text message (Box 223) irrespective of whether that representative is online or offline (Box 223). Alternatively, the user may send out a chat request (Box 224).

If the representative is online but currently not available, the user can only queue (Box 224a). If the representative is offline or refuses, no chat can be conducted and the attempt for communication will come to an end (Box 225). To start a chat session, the user goes into a chat room (Box 226). During the chat session, the user and the representative have an option to invoke the web share function (Box 227) for sharing web documents with each other (Box 228), or this function may be locked (Box 229) to block any web sharing (Box 229a). The chat session may of course be terminated by either party at any time.

The Company Directory (Box 230), which is displayed in a tree diagram format, may be refreshed (Box 231) to update the online/offline status and availability of the company representatives on a real time basis. Upon selection of a specific company (Box 232), its company details (Box 232a) or product catalog (Box 232b) may be reviewed. Upon selection of a specific representative under that company (Box 233), whose details may be reviewed (Box 233a) or a text message may be sent to him/her (Box 233b). The user may also add the representative to the Contact List (Box 234), whereupon the representative will be displayed in the Contact List (Box 221).

The user may send a chat request to the representative (Box 235). If the representative is online but currently not available, the user can only queue (Box 235a). If the representative is offline or refuses, no chat can be conducted and the attempt for communication will come to an end (Box 225). To start a chat session, the user goes into the chat room (Box 226). As described above, during the chat session, the user and the representative may invoke the web share function (Box 227) for sharing web documents (Box 228), or lock this function (Box 229) to block any web sharing (Box 229a). The chat session can be terminated by either party at any time.

As is apparent from the foregoing description, MIOS is an interactive and proactive marketplace interface where customers and traders, or whoever, can meet on equal standing, with an intent to conduct commerce and/or communicate effectively over the Internet. It serves and promotes B-B and B-C. When a trader goes online, his/her storefront is open for business. A customer can seek the trader and review his/her company details or product catalog.

More importantly, the customer can interact with the trader in a two-way communication channel, by exchanging written or voice messages and data files and sharing websites with each other, etc. Such interaction is critical to doing business as MIOS simulates a virtual shopping environment in which customers and product/service providers can meet and talk and show what they want and can offer on a real time basis and in an uninterrupted manner during a single encounter.

To the customers, they can get immediate personal attendance from the salespersons. To the traders, there is no need for them to have a website or webpage to display their products and/or services. They can easily create word, excel and pdf documents or scan images and upload the files to the MIOS system and use them as product/service catalogs. Thus, every participating trader has an equal standing in the open marketplace (the Company Directory) even if he/she does not have much resources (fancy and expensive websites or webpages).

MIOS adds the human element that is crucial to commerce but is missing from the existing e-commerce environments. It allows instant real time exchange of information and data, and the interactivity in the process makes online commerce work as it should be in the real world. Using MIOS, the traders have the ability to keep the customers attended and interested, and the customers can instantly obtain any information and negotiate a better price and so on as if they were actually visiting a shop in the street.

Given the advance in technologies relating to personal communication, it is envisaged that MIOS users may use any types of communication devices, other than the personal computers 50, such as PDA (personal digital assistants) and 3G (third generation) mobile phones.

The invention has been given by way of example only, and various other modifications of and/or alterations to the described embodiment may be made by persons skilled in the art without departing from the scope of the invention as specified in the appended claims.

1. An interactive online marketplace system comprising at least one server, a database associated with the server for storing details of traders and customers including information of products and/or services provided by the traders, each of the traders and customers being identified by or as at least one user having a unique identity code, communication devices for use by the traders and customers and connectable to the server, a website associated with the server for visit by the customers using the communication devices, and a webpage for display on the communication device of a visiting customer, the webpage including a directory of the traders in a multi-level representation that includes hyper links to corresponding users representing the traders based on their identity codes for establishing a two-way online communication channel via the server between the visiting customer and one of the traders selected by that customer.

2. The interactive online marketplace system as claimed in claim 1, wherein the directory is to be displayed in the format of a tree diagram.

3. The interactive online marketplace system as claimed in claim 1, wherein the traders in the directory are listed according to their business nature at one level and then product/service type at a lower level.

4. The interactive online marketplace system as claimed in claim 3, wherein the traders in the directory are listed according to their names, or the names of their representatives, at a further lower level.

5. The interactive online marketplace system as claimed in claim 4, wherein the names are associated with means for obtaining information from the traders represented by the names.

6. The interactive online marketplace system as claimed in claim 4, wherein the names are associated with the hyper links respectively to establish a said two-way online communication channel between two users for a chat session comprising sending a message.

7. The interactive online marketplace system as claimed in claim 6, wherein the message comprises one of text and voice messages.

8. The interactive online marketplace system as claimed in claim 7, wherein the message includes sharing one of file and webpage.

9. The interactive online marketplace system as claimed in claim 4, wherein the names are selectable for adding to a contact list included in the webpage, with each name in the contact list being a hyper link to the corresponding user for communication.

10. The interactive online marketplace system as claimed in claim 9, wherein the contact list includes an indication to show online status of the users represented by the names in the contact list.

11. An interactive online marketplace method comprising the steps of:
(a) providing at least one server and a database associated with the server for storing details of traders and customers including information of products and/or services provided by the traders, and identifying each of the traders and customers by or as at least one user having a unique identity code;
(b) providing communication devices for use by the traders and customers and connectable to the server;
(c) providing a website associated with the server for visit by the customers using the communication devices; and
(d) providing a webpage for display on the communication device of a visiting customer, the webpage including a directory of the traders in a multi-level representation that includes hyper links to corresponding users representing the traders based on their identity codes for establishing a two-way online communication channel via the server between the visiting customer and one of the traders selected by that customer.

12. The interactive online marketplace method as claimed in claim 11, step (d) includes displaying the directory in the format of a tree diagram.

13. The interactive online marketplace method as claimed in claim 11, wherein step (d) includes listing the traders in the directory according to their business nature at one level and then product/service type at a lower level.

14. The interactive online marketplace method as claimed in claim 13, wherein step (d) further includes listing the traders in the directory according to their names, or the names of their representatives, at a further lower level.

15. The interactive online marketplace method as claimed in claim 14, wherein step (d) further includes providing means associated with the names for obtaining information from the traders represented by the names.

16. The interactive online marketplace method as claimed in claim 14, wherein step (d) further includes associating the names with the hyper links respectively to establish a said two-way online communication channel between two users for a chat session comprising sending a message.

17. The interactive online marketplace method as claimed in claim 16, wherein the message comprises one of text and voice messages.

18. The interactive online marketplace method as claimed in claim 17, wherein the message includes sharing one of file and webpage.

19. The interactive online marketplace method as claimed in claim 14, wherein step (d) further includes rendering the names selectable for adding to a contact list included in the webpage, with each name in the contact list being a hyper link to the corresponding user for communication.

20. The interactive online marketplace method as claimed in claim 19, wherein step (d) further includes including in the contact list an indication to show online status of the users represented by the names in the contact list.
